(19) United States
(12) Patent Application Publication
(10) Pub. No.: US 2014/0199595 A1
(43) Pub. Date: Jul. 17, 2014

(54) Method of Synthesis of a Compound LiM1-x-y-zNyQzFexPO4 and Use Thereof as Electrode Material for a Lithium Battery

(71) Applicant: Commissariat A L'Energie Atomique et aux Energies Alternatives, Paris (FR)

(72) Inventors: Lorraine Raboin, Scy-Chazelles (FR); Thibaut Gutel, Veurey-Voroize (FR)

(73) Assignee: Commissariat A L'Energie Atomique et aux Energies Alternatives, Paris (FR)

(21) Appl. No.: 14/156,825

(22) Filed: Jan. 16, 2014

(30) Foreign Application Priority Data
Jan. 17, 2013 (FR) 1350399

(51) Int. Cl. H01M 4/58; C01B 25/45

(52) U.S. Cl. CPC H01M 4/5825; C01B 25/45
USPC 429/221; 252/182.1

(57) ABSTRACT

The invention relates to a method of manufacture of a compound of formula LiM_{1-x-y-z}N_{y}Q_{z}FeₓPO₄, the compound thus obtained, and to a method of manufacture of a composite material comprising LiM_{1-x-y-z}N_{y}Q_{z}FeₓPO₄ and carbon, the composite material thus obtained, as well as an electrode comprising this composite material, and a lithium battery comprising such an electrode, in which: M is a transition element selected from Co, Ni, Mn and Fe; N is a doping element different from M and Q; Q is a transition element selected from Co, Ni, Mn and Fe but different from M; 0≦x≦1; 0≦y≦0.15; 0≦z≦1; and 0<x+y+z≦1.

The invention relates to a method of manufacture of a compound of formula LiM_{1-x-y-z}N_{y}Q_{z}FeₓPO₄, and the compound thus obtained.

It also relates to a method of manufacture of a composite material comprising this compound and carbon, the composite material thus obtained, as well as an electrode comprising this composite material, and a lithium battery comprising said electrode.

Lithium batteries comprise at least two electrodes based on different active materials, and an electrolyte through which the Li⁺ cations are able to migrate from one electrode to the other depending on the manner of use. These lithium batteries are being used increasingly as autonomous energy sources, especially in portable equipment, where they are gradually replacing nickel-cadmium (Ni—Cd) and nickel-metal hydride (Ni-MH) batteries. For some years now, sales of Li-ion batteries have exceeded those of Ni-MH and Ni—Cd batteries. This development is explained by the continuous improvement in the performance of lithium batteries, thus endowing them with energy densities per unit mass and per unit volume far higher than those offered by the Ni—Cd and Ni-MH types. Whereas the first Li-ion batteries had an energy density of about 85 Wh/kg, nearly 200 Wh/kg can now be obtained (energy density referred to the mass of the complete Li-ion cell). For comparison, Ni-MH batteries peak at 100 Wh/kg and Ni-Cd batteries have an energy density of the order of 50 Wh/kg. The new generations of lithium batteries are already under development for ever more diversified applications (hybrid or all-electric cars, storing the energy from photovoltaic cells, etc.).

The active compounds of electrodes used in commercial batteries are, for the positive electrode, lamellar compounds such as LiCoO₂, LiNiO₂ and the mixed compounds Li(Ni, Co, Mn, Al)O₂ or compounds of spinel structure with a composition close to LiMn₂O₄. The negative electrode is generally of carbon (graphite, coke, etc.) or optionally the compound of spinel structure Li₄Ti₅O₁₂ or a metal forming an alloy with lithium (Sn, Si, etc.). The theoretical and practical specific capacities of the positive electrode compounds mentioned are about 275 mAh/g and 140 mAh/g respectively for the oxides of lamellar structure (LiCoO₂ and LiNiO₂) and 148 mAh/g and 120 mAh/g for spinel LiMn₂O₄. In all cases, an operating potential relative to metallic lithium close to 4 Volts is obtained.

Since the emergence of lithium batteries, several generations of positive electrode materials have successively made their appearance. The concept of insertion/extraction of lithium into/from the electrode materials was extended a few years ago to the three-dimensional structures constructed from polyanionic entities of the type XOₙ^{m-} (X═P, S, Mo, W . . . ; 2≦n≦4; 2≦m≦4). Moreover, there is now keen interest in the lithium-containing metal phosphates with crystallographic structure of the olivine type and of general formula LiMPO₄ (M=Fe, Mn, Co, Ni).

Among the four compounds of formula LiMPO₄, only lithium iron phosphate LiFePO₄ is currently capable of meeting expectations experimentally, bearing in mind a practical capacity that is now close to the theoretical value; namely 170 mAh/g. Nevertheless, this compound, stressing the electrochemical couple Fe³⁺/Fe²⁺, operates at 3.4 V vs. Li⁺/Li. This rather low potential leads at the maximum to an energy density per unit mass of 580 Wh/kg of LiFePO₄. However, it is known that the phosphates of manganese, of cobalt and of nickel, isotypes of LiFePO₄, have higher potentials of lithium ion extraction/insertion, respectively 4.1 V, 4.8 V and 5.1 V vs. Li⁺/Li. The theoretical specific capacities of these three compounds are close to that of LiFePO₄.

The formation of a mixed compound of formula LiM₁₋ₓFeₓPO₄ (0≦x≦1) obtained by substitution of the iron with transition metals of the type Mn, Co and Ni offers new perspectives. Such materials are promising as they have higher operating potentials than lithium iron phosphate while retaining equivalent theoretical specific capacities. Conversely, from an experimental standpoint, important progress still needs to be made in order to reach satisfactory values of practical specific capacities.

To summarize, to meet the ever increasing demands for energy (per unit of mass and/or of volume), new materials of electrodes of Li-ion batteries giving even better performance are indispensable.

The invention aims to solve this problem by proposing a method of synthesis of compounds of the lithium-containing mixed phosphate type having a particular morphology permitting improved conductivity, low electrochemical polarization and a high specific capacity, which can be used as electrode material, in particular positive, in commercial lithium batteries.

The method of synthesis of the invention is a rapid method that is implemented at low temperature.

For this purpose, the invention proposes a method of manufacture of a compound of the following formula I:

LiM_{1-x-y-z}N_{y}Q_{z}FeₓPO₄ formula I

in which:
M is a transition element selected from Co, Ni, Mn and Fe,
N is a doping element different from M and Q, and/or a vacancy on the sites of lithium and/or of M and/or of Q and/or of P and/or of O,
Q is a transition element selected from Co, Ni, Mn and Fe but different from M,
0≦x≦1,
0≦y≦0.15,
0≦z≦1, and
0<x+y+z≦1,
   characterized in that it comprises the following steps:

a) mixing the precursors of Li, M, N, Fe, P and ascorbic acid in an aqueous solvent preferably containing a glycol compound,

b) microwave heating of the mixture obtained in step a) at a temperature between 100 and 300° C., preferably at a temperature of 160° C. and at a pressure between 0.5 and 50 bar, preferably a pressure of 3 bar, for a time between 1 and 60 minutes, preferably for 30 minutes, and

c) washings of the product obtained in step b) with ethanol and water.

Preferably, these washings consist of one washing with ethanol, followed by two washings with water.

In the compound of formula I, the doping element N is preferably boron or aluminium or mixtures of boron and aluminium.

Preferably, in step a), the glycol compound is ethylene glycol and/or diethylene glycol and/or triethylene glycol and/or tetraethylene glycol.

Preferably, in step a), the aqueous solvent comprises a glycol compound and the volume ratio of water to glycol compound is between 9 and 1/9, and is preferably equal to 1/4.

Also preferably, in step a), the amount of ascorbic acid is between 0.01% and 0.5 wt %, relative to the amount of Fe.

Still preferably, in step a), the precursor of Li is selected from a lithium hydroxide, acetate, nitrate, chloride, hydrogen phosphate, and is preferably lithium hydroxide monohydrate.

Also preferably, in step a), the precursors of Mn, Fe, Ni and Co are selected from a sulphate, an acetate, an oxalate, a chloride, a hydroxide and a nitrate of Mn, Fe, Ni and Co respectively; preferably the precursor of Fe is iron sulphate heptahydrate (FeSO₄.7H₂O), the precursor of manganese is manganese sulphate monohydrate (MnSO₄.H₂O), the precursor of Ni is nickel sulphate hexahydrate, and the precursor of Co is cobalt sulphate heptahydrate.

Also preferably, in step a), the precursor of phosphorus is selected from phosphoric acid (H₃PO₄), diammonium hydrogen phosphate ((NH₄)₂HPO₄), ammonium dihydrogen phosphate (NH₄H₂PO₄), and is preferably phosphoric acid (H3PO₄).

In a preferred embodiment, in step a), the precursors of M, N, Q, Fe and P are mixed in the desired stoichiometric amounts of M, N, Q, Fe and P in the final compound of formula I and the precursor of Li in an amount of Li greater than the desired stoichiometric amount of Li in the final compound of formula I.

Preferably, an amount of Li corresponding to 3 equivalents, in moles, will be used, to obtain one equivalent in mole of Li in the final compound of formula I.

The invention also proposes a method of manufacture of a composite material of the following formula II:

C—LiM_{1-x-y-z}N_{y}Q_{z}FeₓPO₄ formula II

in which:
M is a transition element selected from Co, Ni, Mn and Fe,
N is a doping element different from M and Q, and/or a vacancy on the sites of the lithium and/or of M and/or of P and/or of O, in mol,
Q is a transition element selected from Co, Ni, Mn and Fe but different from M, in mol,
0≦x≦1,
0≦y≦0.15,
0≦z≦1, and
0<x+y+z≦1,
   characterized in that it comprises the following steps:

a) mixing the precursors of Li, M, N, Fe, P and ascorbic acid in an aqueous solvent preferably containing a glycol compound,

b) microwave heating of the mixture obtained in step a) at a temperature between 100 and 300° C., preferably at a temperature of 160° C. and at a pressure between 0.5 and 50 bar, preferably a pressure of 3 bar, for a time between 1 and 60 minutes, preferably for 30 minutes,

c) washings of the product obtained in step b) with ethanol and water, and

d) mixing the compound of formula I obtained in step c) with carbon powder having a specific surface greater than 700 m²/g.

In formula II, as in formula I, the doping element N is preferably boron or aluminium or mixtures thereof.

In step a), the glycol compound is preferably ethylene glycol and/or diethylene glycol and/or triethylene glycol and/or tetraethylene glycol.

The invention also proposes an electrode, characterized in that it comprises a composite material of formula I and/or of formula II obtained by the methods according to the invention.

The invention further proposes a Li-ion battery, characterized in that it comprises an electrode according to the invention.

The invention also proposes a compound of the following formula I:

LiM_{1-x-y-z}N_{y}Q_{z}FeₓPO₄ formula I

in which:
M is a transition element selected from Co, Ni, Mn and Fe,
N is a doping element different from M and Q, and/or a vacancy on the sites of the lithium and/or of M and/or of P and/or of O,
Q is a transition element selected from Co, Ni, Mn and Fe but different from M,
0≦x≦1,
0≦y≦0.15,
0≦z≦1, and
0<x+y+z≦1,
   obtained by the method of synthesis of the invention, having the form of platelets, two dimensions of which are between 20 nm and 500 nm and whose thickness is between 1 and 100 nm.

The invention finally proposes a composite material of the following formula II:

C—LiM_{1-x-y-z}N_{y}Q_{z}FeₓPO₄ formula II

in which:
M is a transition element selected from Co, Ni, Mn and Fe,
N is a doping element different from M and Q, and/or a vacancy on the sites of the lithium and/or of M and/or of P and/or of O,
Q is a transition element selected from Co, Ni, Mn and Fe but different from M,
0≦x≦1,
0≦y≦0.15,
0≦z≦1, and
0<x+y+z≦1,
   characterized in that it comprises a compound of formula I according to the invention and carbon and in that it has a specific surface greater than or equal to 80 m²/g.

Preferably, in the compound of formula I, as in the compound of formula II, the doping element N is aluminium or boron or mixtures thereof.

The invention will be better understood and other features and advantages of the invention will become clearer on reading the explanatory description which follows and which refers to the figures in which:

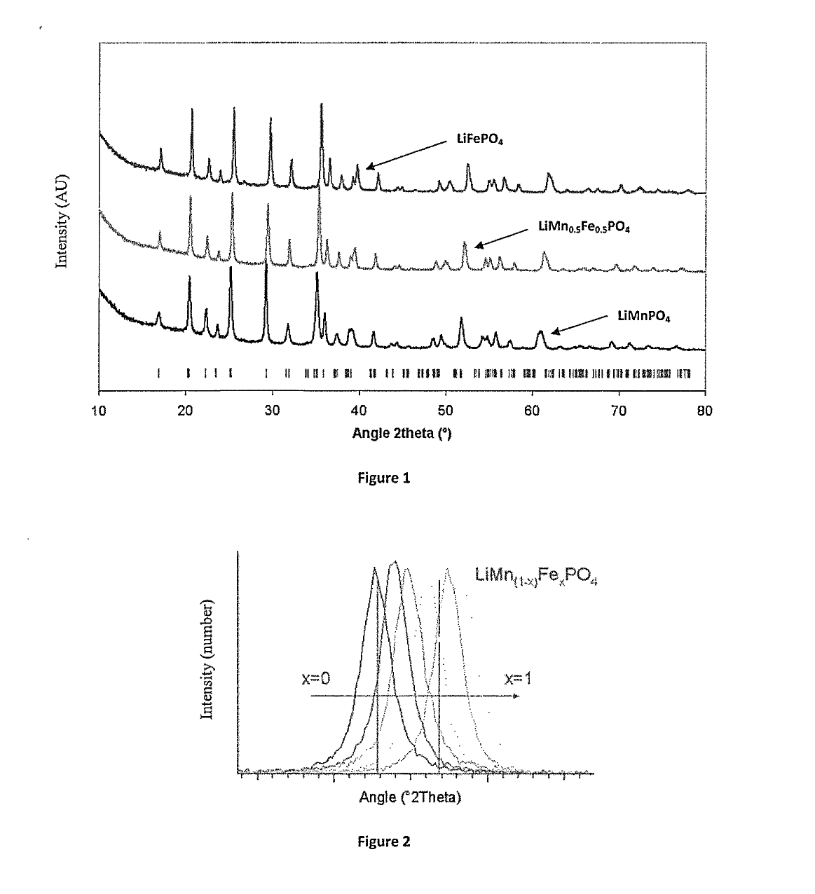

FIG. 1 shows X-ray diffraction patterns (δ_{CuKα}) of the compounds of formula LiMnPO₄, LiMn_{0.5}Fe_{0.5}PO₄ and LiFePO₄ prepared according to example 1. In the insert, the crystal structure of LiMnPO₄ is represented in the plane (a, b); the axis c is perpendicular to the plane of the figure,

FIG. 2 is an enlargement of the diffraction peak at 2θ=25° of the X-ray diffraction patterns of the compounds of formula LiMm₁₋ₓFeₓPO₄ with x=0, 0.2, 0.4, 0.6, 0.8 and 1, respectively, prepared by the method of the invention,

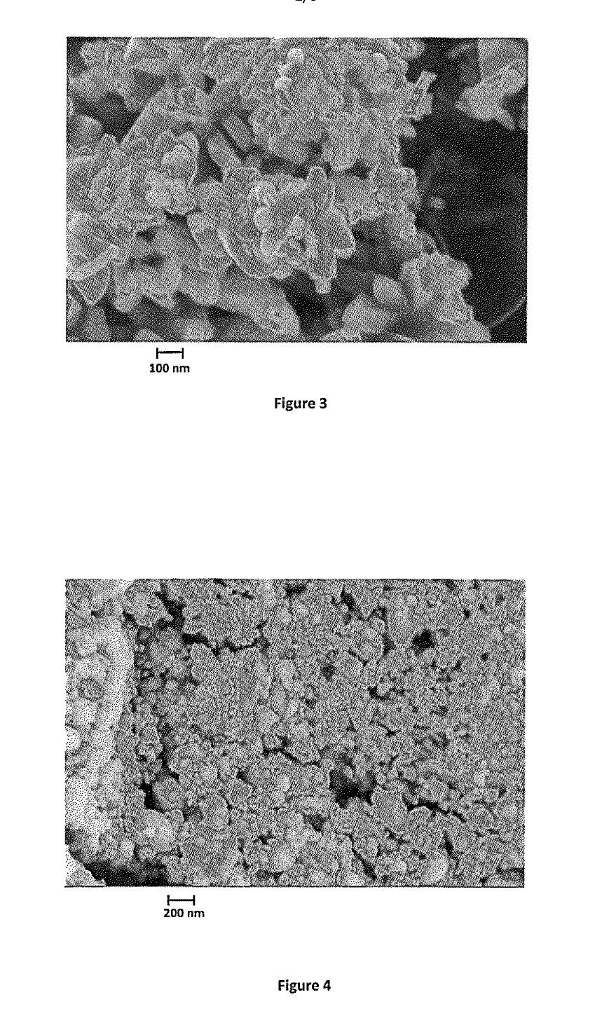

FIG. 3 shows the image obtained by scanning electron microscopy (FEG-SEM) of the material LiMn_{0.5}Fe_{0.5}PO₄ prepared according to example 1, at a magnification of 200 000,

FIG. 4 shows the image obtained by scanning electron microscopy (FEG-SEM) of the composite material C—LiMn_{0.5}Fe_{0.5}PO₄ prepared according to example 1, at a magnification of 100 000,

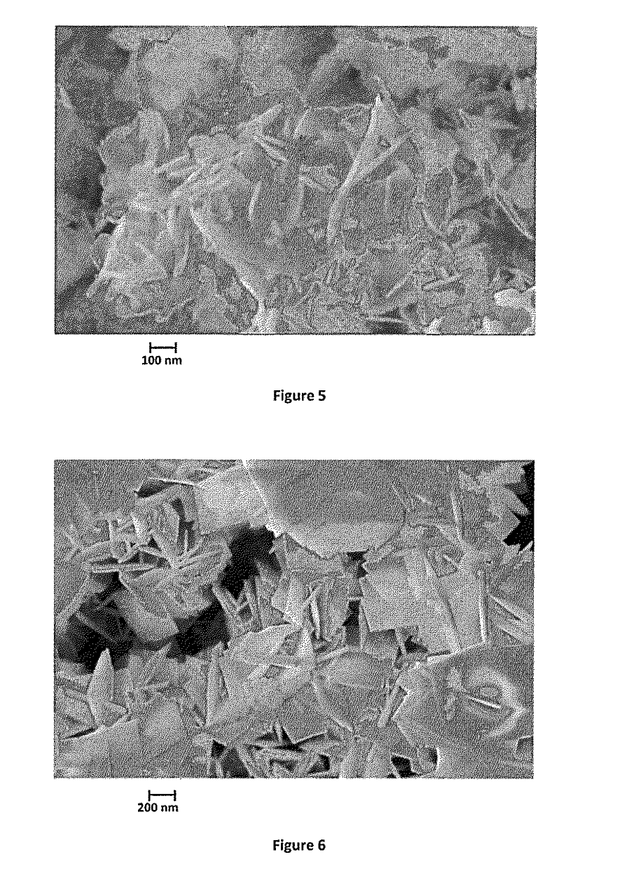

FIG. 5 shows the image obtained by scanning electron microscopy (FEG-SEM) of the material LiMnPO₄ prepared in example 1, at a magnification of 200 000,

FIG. 6 shows the image obtained by scanning electron microscopy (FEG-SEM) of the composite material LiFePO₄ obtained in example 1, at a magnification of 100 000,

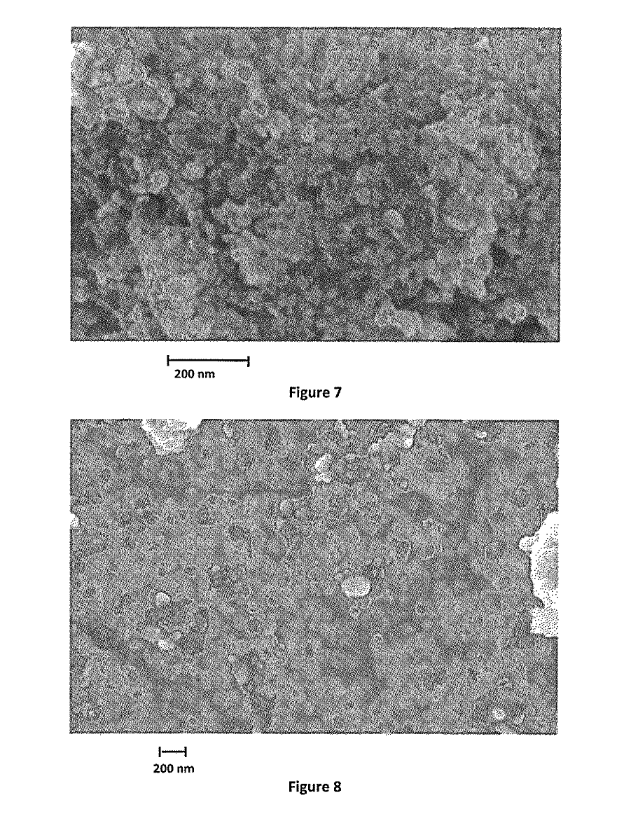

FIG. 7 shows the image obtained by scanning electron microscopy (FEG-SEM) of the material C—LiMnPO₄ obtained in example 1, at a magnification of 100 000,

FIG. 8 shows the image obtained by scanning electron microscopy (FEG-SEM) of the composite material C-LiFePO₄ obtained in example 1, at a magnification of 100 000,

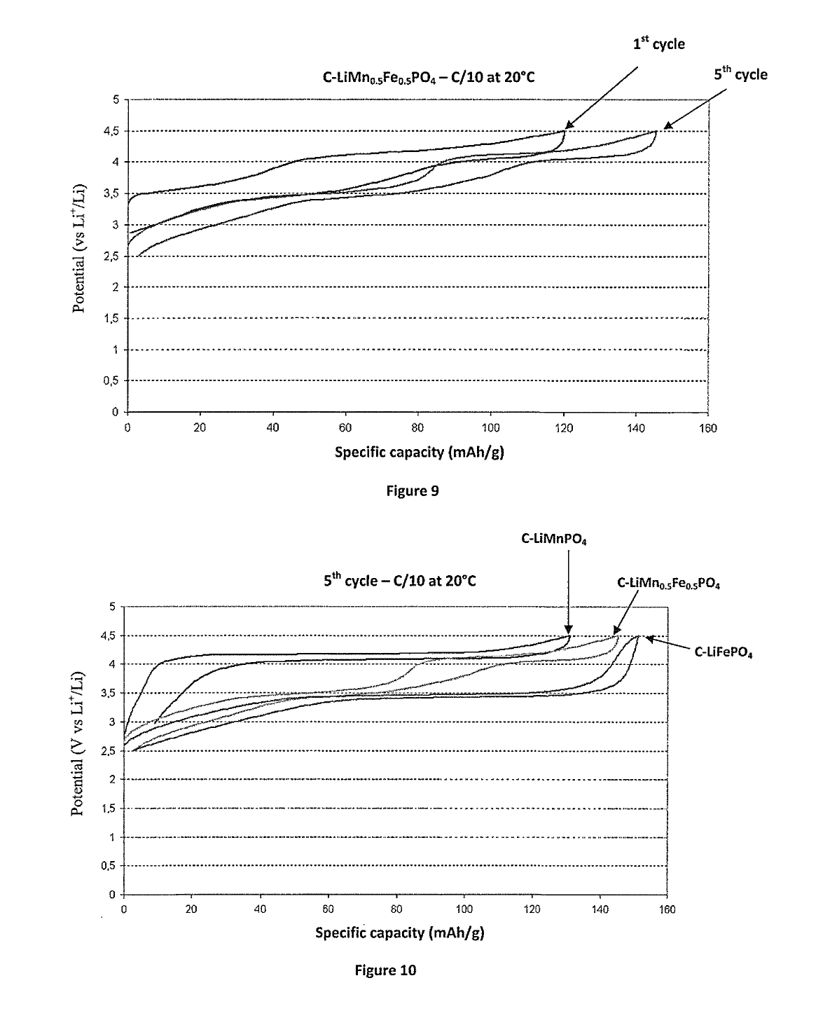

FIG. 9 is a diagram showing the first and fifth charge/discharge cycles in intentiostatic mode (C/10 regime; 20° C.) of the composite material C—LiMn_{0.5}Fe_{0.5}PO₄ (15 wt % of carbon), obtained in example 1, between 2.5 and 4.5V,

FIG. 10 shows the charge/discharge curves of the fifth charge/discharge cycles in intentiostatic mode (C/10 regime; 20° C.) of the composite materials C—LiMnPO₄, C—LiMn_{0.5}Fe_{0.5}PO₄ and C—LiFePO₄ (15 wt % of carbon), obtained in example 1, between 2.5 and 4.5V,

FIG. 11 shows the variation of the specific capacity in discharge as a function of the number of cycles in a C/10 regime at 20° C. and 55° C. effected with the composite material C—LiMn_{0.5}Fe_{0.5}PO₄, obtained in example 1, between 2.5 and 4.5V, and

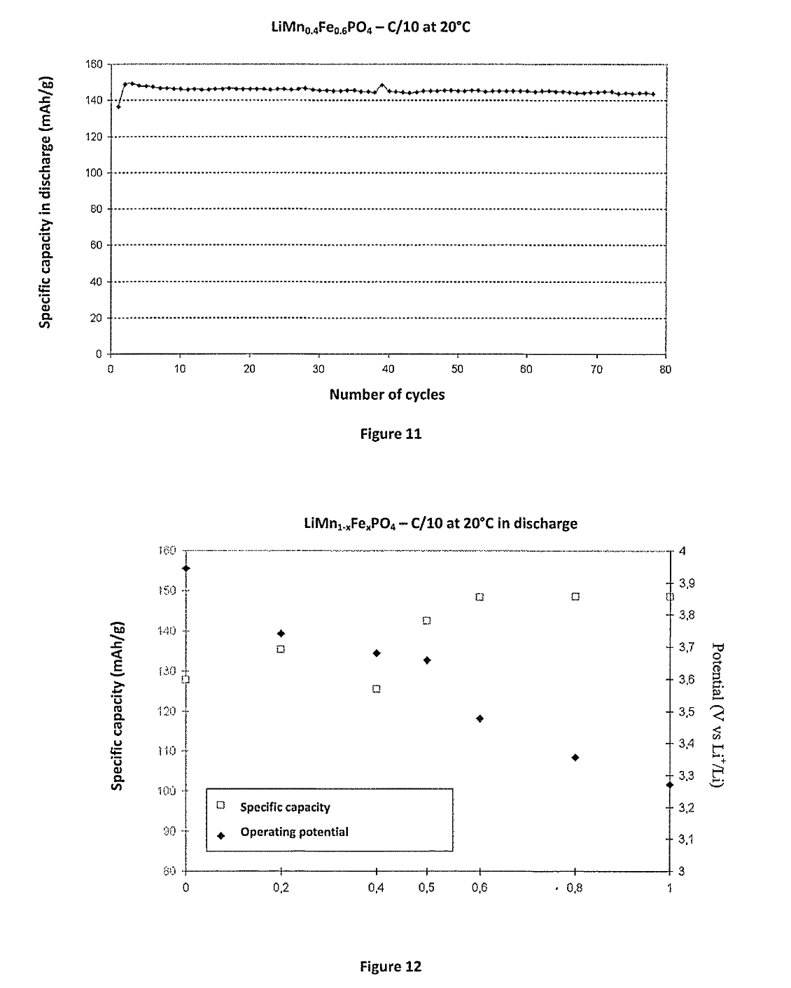

FIG. 12 shows the variation in the operating potential and specific capacity in discharge in a C/10 regime at 20° C. of the composite materials C—LiMn₁₋ₓFeₓPO₄ as a function of the value of X.

The invention aims to provide a method of manufacture of materials for the positive electrode for a lithium battery, in particular.

These materials are of the type LiM₁₋ₓFeₓPO₄ (M=Co, Ni, Mn with 0≦x≦1). In particular, the mixed phosphate of manganese and iron of formula LiMn₁₋ₓFeₓPO₄, and of olivine structure, is of considerable interest as the active material of a positive electrode on account of its operating potential that is relatively high, but is still compatible with conventional electrolytes. The potential is between 3.4 V (LiFePO₄) and 4.1 V (LiMnPO₄) vs. Li⁺/Li associated with a theoretical specific capacity of the order of 170 mAh/g. From a theoretical standpoint, this compound thus has a higher energy density than most of the known electrode materials (up to 700 Wh/kg).

Nevertheless, the practical capacities of the compounds LiMn₁₋ₓFeₓPO₄ reported in the literature are still below the expected theoretical values. Moreover, it has not been clearly determined what ratio of manganese and iron would be optimum in these materials in terms of electrochemical performance, and to what extent the mixed compounds LiMn₁₋ₓFeₓPO₄ are stable as cathodes in Li-ion batteries. As the redox potential of the Fe²⁺/Fe³⁺ couple in the compounds of olivine structure is 600-700 mV lower than for the Mn²⁺/Mn³⁺ couple, it is important to optimize the Mn/Fe ratio in LiMn₁₋ₓFeₓPO₄ to ensure maximum capacity in the highest range of potential. It is a question of advantageously combining the qualities of the LiFePO₄/FePO₄ couple (better electronic and ionic conductivity) and LiMnPO₄/MnO₄ couple (higher energy density).

A specific method of synthesis giving a lithium-containing carbon/mixed phosphate composite [C—LiMn₁₋ₓFeₓPO₄] of particular morphology permitting improved conductivity, low electrochemical polarization and a high specific capacity, is indispensable for really envisaging the future use of this material in commercial lithium batteries.

For this purpose, the invention proposes a method of manufacture of a compound of the following formula I:

LiM_{1-x-y-z}N_{y}Q_{z}FeₓPO₄ formula I

in which:
M is a transition element selected from Co, Ni, Mn and Fe,
N is a doping element different from M and Q, and/or a vacancy on the sites of the lithium and/or of M and/or of Q and/or of P and/or of O,
Q is a transition element selected from Co, Ni, Mn and Fe but different from M,
0≦x≦1,
0≦y≦0.15,
0≦z≦1, and
0<x+y+z≦1,
   which, once mixed with carbon, makes it possible to obtain a composite material of the following formula II:

C—LiM_{1-x-y-z}N_{y}Q_{z}FeₓPO₄ formula II

in which:
M is a transition element selected from Co, Ni, Mn and Fe,
N is a doping element different from M and Q, and/or a vacancy on the sites of the lithium and/or of M and/or of P and/or of O,
Q is a transition element selected from Co, Ni, Mn and Fe but different from M,
0≦x≦1,
0≦y≦0.15,
0≦z≦1, and
0<x+y+z≦1,
   this composite material being usable, in particular, for the manufacture of an electrode, more particularly positive, of a Li-ion battery.

Preferably, in the compound of formula I, 0<x+y+z<1, 2≦x≦0.6 and z=0.

The method of synthesis of the compound of formula I is microwave-assisted solvothermal synthesis.

This method comprises the following steps:

a) mixing the precursors of Li, M, N, Fe, P and ascorbic acid in an aqueous solvent preferably containing a glycol compound, such as ethylene glycol, and/or diethylene glycol, and/or triethylene glycol, and/or tetraethylene glycol,

b) microwave heating of the mixture obtained in step a) at a temperature between 100 and 300° C., preferably at a temperature of 160° C. and at a pressure between 0.5 and 50 bar, preferably a pressure of 3 bar, for a time between 1 and 60 minutes, preferably for 30 min, and

c) washings of the product obtained in step b) with ethanol and water.

The compounds that can be obtained by this method can be LiFePO₄, a compound of the type LiM₁₋ₓFeₓPO₄ where M represents a transition element selected from Co, Ni, Mn and Fe.

It is also possible to synthesize, by the method of the invention, a compound containing two transition elements, i.e. a compound of the type Li_{1-x-z}N_{y}Q_{z}, N_{y}FeₓPO₄ where M and N are selected from Co, Ni, Mn and Fe but are different from one another.

It is thus possible to obtain for example a compound of the type LiMm_{1-x-z}Ni_{z}FeₓPO₄.

However, as is well known by a person skilled in the art, these compounds can in addition be doped with any element of the periodic table that is, of course, different from M, Q and Fe.

In particular, the doping element can be boron or aluminium or mixtures thereof.

N can also represent a vacancy on the site of the lithium, of M, of Q, of the phosphorus or of the oxygen. In fact, a vacancy on a site of the oxygen can improve the diffusion of the lithium ions.

Regarding a doping element, it is present in a very small amount in the compound of the invention, i.e. at a value below 15 mol %.

Various lithium precursors can be used such as a lithium hydroxide, in particular lithium hydroxide monohydrate LiOH.H₂O, a lithium acetate such as LiOAc.2H₂O, a lithium chloride LiCl, a lithium nitrate LiNO₃, or else a lithium hydrogen phosphate LiH₂PO₄.

Preferably, in the method of the invention, lithium hydroxide monohydrate is used.

Various precursors of manganese, of iron, of nickel and of cobalt can also be used, such as a sulphate, an acetate, an oxalate, a chloride, a hydroxide or a nitrate of these compounds.

Thus, for manganese, precursors of formulae Mn0Ac₂.4H₂O, MnSO₄.H₂O, MnCl₂, MnCO₃, MnNO₃.4H₂O, Mnₓ(PO₄)_{y}.H₂O in which x is between 1 and 5 and y is between 1 and 10, Mn(OH)_{z} in which z is between 2 and 4, can be used. Preferably, a precursor of manganese that is manganese sulphate monohydrate MnSO₄.H₂O will be used.

Iron sulphate heptahydrate (FeSO₄.7H₂O) is preferably used as precursor of iron.

Nickel sulphate hexahydrate will preferably be used as precursor of nickel, and cobalt sulphate heptahydrate as precursor of cobalt.

As precursor of phosphorus, it will be possible to use phosphoric acid, ammonium mono- and dihydrogen phosphate and even lithium hydrogen phosphate.

Preferably, phosphoric acid will be used.

In the prior art, the syntheses of the compounds of formula I were carried out in the solid at high temperature, i.e. at a temperature greater than or equal to 600° C., such temperatures being necessary to permit decomposition of the precursors of lithium, of manganese, and of phosphorus, the complete reaction of formation of the compound as well as total evaporation of the volatile species.

However, although it is difficult to prepare the electrochemically active compound of formula I at low temperature, the inventors discovered that synthesis at low temperature was necessary in order to limit excessive growth of the particles or the formation of agglomerates as far as possible.

Thus, the method of the invention uses a method of synthesis in solution at a temperature between 100 and 300° C., at a pressure between 0.5 and 50 bar for a time of less than 60 minutes, preferably a time of 30 minutes, and synthesis is preferably carried out at a temperature of 160° C. at a pressure of 3 bar for 30 minutes.

This synthesis is carried out in a microwave-heated reactor.

The power of the microwave oven is fixed as a function of the mass of the sample to be treated, but the temperature of the reaction mixture is maintained in the temperature range and for a duration and at a pressure as defined above.

The reaction takes place in an aqueous solvent, which can consist of water only, but which preferably contains a glycol compound.

As glycol compound that can be used, we may mention ethylene glycol, diethylene glycol, triethylene glycol and tetraethylene glycol, and mixtures thereof.

However, diethylene glycol has proved particularly suitable.

The reaction mixture in step a) comprises ascorbic acid in order to prevent oxidation of the iron (II) ions.

Between 0.01 wt % and 0.5 wt % of ascorbic acid, relative to the amount of iron, is used.

To remove the solvent and the unwanted species such as the sulphates and hydroxides derived from the precursors, the product obtained after step b) is simply washed with ethanol and with water and then dried in a stove under air at about 50-60° C. One washing with ethanol followed by two washings with water has proved sufficient.

Thus, in contrast to the synthesis in the solid used in the prior art for synthesizing this type of compound, there is no evaporation of the unwanted species and solvents in an oven at high temperature.

Owing to the presence of PO₄³⁻, P₂O₇⁴⁻, and PO₃⁻ groups, the compounds of formula I are relatively insulating from an electronic standpoint. That is why deposition of carbon in situ (during synthesis) or ex situ (post-treatment step) on the surface of the particles of the compounds of formula I is necessary for obtaining good electrical performance. Carbon makes it possible to increase the electronic conductivity but also to limit agglomeration of the particles under the effect of the synthesis temperature. In the prior art, this deposition of carbon is generally carried out by thermal decomposition of an organic substance under reducing atmosphere simultaneously with the synthesis of the compound of formula I.

Once again, to limit the temperatures of synthesis of the composite of the invention, the invention proposes synthesizing a composite material of the following formula II:

C—LiM_{1-x-y-z}N_{y}Q_{z}FeₓPO₄ formula II

in which:
M is a transition element selected from Co, Ni, Mn and Fe,
N is a doping element different from M and Q, and/or a vacancy on the sites of the lithium and/or of M and/or of P and/or of O,
Q is a transition element selected from Co, Ni, Mn and Fe but different from M,
0≦x≦1,
0≦y≦0.15,
o≦z≦1, and
0<x+y+z≦1,
   simply by carrying out intimate mixing, by vigorous grinding, under air, of the particles of the compounds of formula I prepared by the method of synthesis of the invention with carbon with a high specific surface, i.e. above 700 m²/g.

Preferably, in the compound of formula II, 0<x+y+z<1, 2≦x≦0.6 and z=0.

Thus, the reaction of formation proper of the composite material of formula II takes place during the mixing of the compound of formula I and carbon. Mixing is carried out, for example, by grinding in a 50-ml agate bowl containing 20 agate balls of 1 cm diameter rotating at 500 rev/min for 4 h.

It is preferable to use a high proportion of carbon relative to the compound of formula I.

Preferably from 5 to 20 wt % of carbon with high specific surface will be used, relative to the weight of the compound of formula I, more preferably 15 wt %.

Manganese phosphate, LiMn₁₋ₓFeₓPO₄, crystallizes in the Pnma space group. This compound is of an olivine type of structure. The latter consists of a compact hexagonal stack of oxygen atoms. The lithium ions, manganese ions and the iron ions are localized in half of the octahedral sites whereas phosphorus occupies ⅛ of the tetrahedral sites. A simplified representation of the structure of LiMm₁₋ₓFeₓPO₄ is presented in the insert of FIG. 1. This figure also shows the X-ray diffraction pattern of the compounds of formula LiMnPO₄, LiMn_{0.5}Fe_{0.5}PO₄ and LiFePO₄ prepared by the method of the invention. In the case of the compound LiMm₁₋ₓFeₓPO₄, the lattice parameters are of the order of 10.44 Å for a, 6.09 Å for b and 4.75 Å for c. These compounds are free from impurities.

The particles of the compound of formula I obtained by the method of the invention have little or no agglomeration together, as shown in FIGS. 3, 5 and 7, which are images taken with the scanning electron microscope (FEG-SEM) of the compounds of formula LiMn_{0.5}Fe_{0.5}PO₄ (FIG. 3), LiMnPO₄ (FIG. 5) and LiFePO₄ (FIG. 6) prepared by the method of synthesis according to the invention.

Moreover, the method of synthesis of the compounds of formula I of the invention at low temperature leads to a smoothed morphology of the particles, which are of nanometric size, i.e. as can be seen in FIGS. 3, 5 and 6, the particles of the compound of formula I take the form of platelets, two dimensions of which are between 50 and 500 nm and whose thickness is between 1 and 100 nm.

The composite material of formula II obtained from the compounds of formula I prepared according to the method of the invention has a quite different morphology: the carbon served for coating the particles, and as shown in FIGS. 4, 6 and 8, which show respectively the composite material of formula II obtained from the compound of formula I LiMn_{0.5}, Fe_{0.5}, which is shown in FIG. 3, the composite material of formula II obtained from the compound of formula I shown in FIG. 5, and the composite material of formula II obtained from the compound of formula I shown in FIG. 8, the composite materials of the invention take the form of spherical particles.

The compounds of formula I obtained by the method of the invention have a high specific surface, greater than or equal to 15 m²/g.

As the carbon used for obtaining the composite material of the invention has a specific surface preferably greater than 700 m²/g, the specific surface of the composite material obtained with the compounds of formula I of the invention, and by the method of the invention, have a specific surface greater than or equal to 80 m²/g.

The specific surface is measured here on the basis of a nitrogen adsorption isotherm at 77K on the surface of the material (BET)

The composite material of formula II of the invention is advantageously used for manufacturing a positive electrode of a lithium battery.

These electrodes are composed of a dispersion of the composite of formula II with an organic binder that confers a satisfactory mechanical durability.

This electrode is also an object of the invention.

The batteries comprising such an electrode are also an object of the invention.

Such batteries comprise an electrode according to the invention, which is deposited on a metal sheet serving as current collector. This is the positive electrode.

Another electrode, or the so-called negative electrode, is also deposited on a metal sheet.

Any material known by a person skilled in the art can be used to form this negative electrode.

This material can in particular be carbon, silicon, a compound of the type Li₄Ti₅O₁₂, etc.

The two electrodes are separated by a mechanical separator. This separator is impregnated with electrolyte that serves as ionic conductor.

This electrolyte consists of a salt, whose cation is at least partly the lithium ion, and a polar aprotic solvent.

As salt whose cation is at least partly the Li⁺ ion, we may mention LiClO₄, LiAsF₆, LiPF₆, LiBF₄, LiR_{F}SO₃, LiCH₃SO₃, LiN(R_{F}SO₂)₂, LiC(R_{F}SO₂)₃, LiTFSI, LiBOB, LiBETI.

An ionic liquid such as ethylmethylimidazolium TFSI, or butylmethylpyrrolydinium TFSI can also be used as solvent. From a practical standpoint, the positive electrode consisting predominantly of the compound of formula II C—LiMn_{1-x-y-z}N_{y}Q_{z}FeₓPO₄ of the invention can be formed by any known type of means. As an example, the material can be in the form of an intimate dispersion comprising, among other things, the composite of formula II of the invention and an organic binder. The dispersion is then deposited on a metal sheet serving as current collector, for example aluminium. The organic binder, intended to provide good ionic conduction and satisfactory mechanical durability, can, for example, consist of a polymer selected from the polymers based on methyl methacrylate, acrylonitrile, vinylidene fluoride, as well as polyethers or polyesters or else carboxymethylcellulose.

The negative electrode of the Li-ion battery can consist of any known type of material. As the negative electrode is not a source of lithium for the positive electrode, it must consist of a material that can initially accept the lithium ions extracted from the positive electrode, and restore them subsequently. For example, the negative electrode can consist of carbon, most often in the form of graphite, or of a material of spinel structure such as Li₄Ti₅O₁₂. Thus, in a Li-ion battery, the lithium is never in metallic form. It is the Li⁺ cations that go to and fro between the two lithium insertion materials of the negative and positive electrodes, at each charge and discharge of the battery. The active materials of the two electrodes are generally in the form of an intimate dispersion of said lithium insertion/extraction material with an electronically conducting additive and optionally an organic binder as mentioned above.

Finally, the electrolyte of the lithium battery made from the compound of formula I or of formula II of the invention consists of any known type of material. It can, for example, consist of a salt having at least the Li⁺ cation. The salt is, for example, selected from LiClO₄, LiAsF₆, LiPF₆, LiBF₄, LiR_{F}SO₃, LiCH₃SO₃, LiN(R_{F}SO₂)₂, LiC(R_{F}SO₂)₃, LiTFSI, LiBOB, LiBETI. R_{F} is selected from a fluorine atom and a perfluoroalkyl group having between one and eight carbon atoms. LiTFSI is the acronym of lithium trifluoromethanesulphonylimide, LiBOB that of lithium bis(oxalato)borate, and LiBETI that of lithium bis(perfluoroethylsulphonyl)imide. The lithium salt is preferably dissolved in a polar aprotic solvent and can be supported by a separating element arranged between the two electrodes of the battery; the separating element then being impregnated with electrolyte. In the case of a Li-ion battery with polymer electrolyte, the lithium salt is not dissolved in an organic solvent, but in a solid polymer composite such as PEO (polyethylene oxide), PAN (polyacrylonitrile), PMMA (polymethyl methacrylate), PVdF (polyvinylidene fluoride) or a derivative thereof.

For better understanding of the invention, several examples of application thereof will now be described, as purely illustrative and non-limiting examples.

### EXAMPLE 1

Compounds of formula I: LiM_{1-x-y-z}N_{y}Q_{z}FeₓPO₄ in which x=0.2; 0.4; 0.5; 0.6; 0.8 and 1 were synthesized.

The procedure used was identical to that described below for synthesis of LiMn_{0.5}Fe_{0.5}PO₄, with just the amounts of iron sulphate heptahydrate and of manganese sulphate monohydrate being changed to correspond to the desired stoichiometry.

1. Synthesis of LiMn_{0.5}Fe_{0.5}PO₄

0.695 g of iron sulphate heptahydrate (FeSO₄.7H₂O) and 0.423 g of manganese sulphate monohydrate (MnSO₄.H₂O) are dissolved in 10 mL of distilled water containing 65 mg of ascorbic acid (i.e. a concentration of iron and of manganese of 0.05 mol/L). 0.33 mL of aqueous solution of phosphoric acid (H₃PO₄) at 85% is added with magnetic stirring and then 0.63 g of lithium hydroxide monohydrate (LiOH.H₂O or 3 equivalents). A precipitate then quickly forms from the start of addition of the lithium salt. After adding 40 mL of diethylene glycol, the suspension is then put in a sealed 100-mL reactor suitable for microwaving and is treated at 160° C. for 30 minutes in a CEM oven (power of 400 W). The final solution (colourless) contains a beige coloured precipitate. The latter is washed with ethanol and with water, centrifuged and dried for 24 h at 60° C. The powder recovered, of a beige colour, has the composition LiMn_{0.5}Fe_{0.5}PO₄.

FIG. 1 shows the X-ray diffraction pattern of the compound of formula I as well as the X-ray diffraction pattern of the compounds of formula I LiMnPO₄ and LiFePO₄ obtained in the same way.

FIG. 2 shows the shift of the main peak of the compounds synthesized in example 1.

The vertical lines correspond to the Bragg positions calculated for the Pnma space group, and for the lattice parameters a˜10.44 Å; b˜6.09 Å and c˜4.75 Å. The insert of FIG. 1 shows the crystal structure of LiMnPO₄ in the plane (a, b); the axis c being perpendicular to the plane of the figure.

The lithium ions are shown schematically by circles, the octahedra correspond to manganese (MnO₆) and the tetrahedra to phosphorus (PO₄).

FIG. 3 shows the image obtained by scanning electron microscope of the compound of formula I LiMn_{0.5}Fe_{0.5}PO₄, FIG. 5 shows the image obtained by scanning electron microscope of the compound of formula I LiMnFePO₄, and FIG. 7 shows the image obtained by scanning electron microscope of the compound of formula I LiFePO₄.

2. Synthesis of the Composite C-Compound of formula I.

500 mg of powder of compound of formula I obtained in 1. above is put in an agate grinding bowl containing 88 mg of amorphous carbon Ketjen Black EC600J.

This carbon has a specific surface of 1300 m²/g.

The mixture is ground for 4 hours at 500 rev/min.

The composite C—LiMn_{0.5}Fe_{0.5}PO₄ is shown in FIG. 4 whereas the composite C—LiMnFePO₄ is shown in FIG. 6 and the composite material C—LiFePO₄ is shown in FIG. 8.

### EXAMPLE 2

A lithium battery of “button cell” format is assembled with:
a negative electrode of lithium (16 mm diameter, 130 μm thickness) deposited on a nickel disk serving as current collector,
a positive electrode consisting of a disk with a diameter of 14 mm taken from a composite film of 25 μum thickness comprising the material of the invention prepared according to example 1 (90 wt %) and polyvinylidene fluoride (10 wt %) as binder, everything being deposited on an aluminium current collector (sheet with thickness of 20 micrometres), and
a separator impregnated with a liquid electrolyte based on the salt LiPF₆ (1 mol/L) in solution in a mixture of propylene carbonate and dimethyl carbonate.

This battery was tested at 20° C., in a C/10 regime.

As shown in FIG. 9, which presents the cycling curves of the first and fifth cycles obtained when the positive electrode was manufactured from the composite material of formula II C—LiMn_{0.5}Fe_{0.5}PO₄, most of the lithium present is extracted.

This is also the case for the batteries whose positive electrode was manufactured from the composite materials obtained by the methods of the invention, of formula II, C—LiMnFePO₄, C—LiMn_{0.5}Fe_{0.5}PO₄ and C—LiFePO₄, as shown in FIG. 10, which presents the cycling curves of the fifth cycle of these button cells.

The cycling behaviour of the battery obtained with the composite material C—LiMn_{0.5}Fe_{0.5}PO₄ at 20° C. is shown in FIG. 11, showing the variation in specific capacity in discharge of this composite material, as a function of the number of cycles in a C/10 regime at 20° C. and 55° C., between 2.5 and 4.5.

As can be seen in FIG. 11, the specific capacity of the material is about 150 mAh/g and remains stable for 80 cycles.

As can be seen in FIG. 12, which shows the variation in the operating potential and specific capacity in discharge in a C/10 regime at 20° C. of the composite materials of formula II C—LiMm₁₋ₓFeₓPO₄, according to the invention, as a function of the value of x, it appears that when the manganese content increases, the average operating potential of the material increases to the detriment of the electrochemical performance. In fact, the overall loss of conductivity of the material at high manganese content leads to a drop in specific capacity.

1. A method of manufacturing a compound of the following formula I:
LiM_{1-x-y-z}N_{y}Q_{z}FeₓPO₄ formula I
in which:
M is a transition element selected from the group consisting of Co, Ni, Mn and Fe,
N is a doping element different from M and Q,
Q is a transition element selected from the group consisting of Co, Ni, Mn and Fe but different from M,
0≦x≦1,
0≦y≦0.15,
0≦z≦1, and
0<x+y+z≦1,
comprising the following steps:
a) mixing the precursors of Li, M, N, Fe, P and ascorbic acid in an aqueous solvent,
b) microwave heating the mixture obtained in step a) at a temperature between 100 and 300° C. and at a pressure between 0.5 and 50 bar for a time between 1 and 60 minutes, and
c) washing the product obtained in step b) with ethanol and water.

2. The method according to claim 1, wherein in step a), the aqueous solvent comprises a glycol compound and in that the volume ratio of water to glycol compound is between 9 and 1/9.

3. The method according to claim 1, wherein in step a), the amount of ascorbic acid is between 0.01 and 0.5 wt %, relative to the amount of Fe.

4. The method according to claim 1, wherein in step a), the precursor of Li is selected from the group consisting of lithium hydroxide, acetate, nitrate, chloride and hydrogen phosphate.

5. The method according to claim 1, wherein in step a), the precursors of Mn, Fe, Ni and Co are selected from the group consisting of a sulphate, an acetate, an oxalate, a chloride, a hydroxide and a nitrate of respectively Mn, Fe, Ni and Co.

6. The method according to claim 1, wherein in step a), the precursor of phosphorus is selected from the group consisting of phosphoric acid (H₃PO₄), diammonium hydrogen phosphate ((NH₄)₂HPO₄) and ammonium dihydrogen phosphate (NH₄H₂PO₄).

7. The method according to claim 1, wherein in step a), the precursors of M, N, Q, Fe and P are mixed in the desired stoichiometric amounts of M, N, Q, Fe and P in the final compound of formula I and the precursor of Li in an amount of Li greater than the stoichiometric amount in equivalents in moles, than the Li desired in the final compound of formula I.

8. A method of manufacturing a composite material of the following formula II:
C—LiM_{1-x-y-z}N_{y}Q_{z}FeₓPO₄ formula II
in which:
M is a transition element selected from tl ou consis Co, Ni, Mn and Fe,
N is a doping element different from M and Q,
Q is a transition element selected from the group consisting of Co, Ni, Mn and Fe but different from M,
0≦x≦1,
0≦y≦0.15,
0≦z≦1, and
0<x+y+z≦1,
comprisescomprising the following steps:
a) mixing the precursors of Li, M, N, Fe, P and ascorbic acid in an aqueous solvent,
b) microwave heating the mixture obtained in step a) at a temperature between 100 and 300° C. and at a pressure between 0.5 and 50 bar for a time between 1 and 60 minutes,
c) washing the product obtained in step b) with ethanol and water; and
d) mixing the compound thus obtained with carbon powder having a specific surface greater than 700 m²/g.

9. An electrode comprising a material of formula I and obtained by the method according to claim 1.

10. A Li-ion battery comprising an electrode according to claim 9.

11. A compound of the following formula I:
LiM_{1-x-y-z}N_{y}Q_{z}FeₓPO₄ formula I
in which:
M is a transition element selected from the ou consist n Co, Ni, Mn and Fe,
N is a doping element different from M and Q,
Q is a transition element selected from the group consisting of Co, Ni, Mn and Fe but different from M,
0≦x≦1,
0≦y≦0.15,
0≦z≦1, and
0<x+y+z≦1,
obtained by the method according to claim 1 and having the form of platelets, two dimensions of which are between 20 nm and 500 nm and the thickness of which is between 1 and 100 nm.

12. A composite material of the following formula II:
C—LiM_{1-x-y-z}N_{y}Q_{z}FeₓPO₄ formula II
in which:
M is a transition element selected from the group consisting of Co, Ni, Mn and Fe,
N is a doping element different from M and Q,
Q is a transition element selected from the group consisting of Co, Ni, Mn and Fe but different from M,
0≦x≦1,
0≦y≦0.15,
0≦z≦1, and
0<x+y+z≦1,
comprising a compound of formula I according to claim 11 and carbon and having a specific surface greater than or equal to 80 m²/g.
